(19) United States
(12) Patent Application Publication
(10) Pub. No.: US 2018/0257249 A1
(43) Pub. Date: Sep. 13, 2018

(54) RAZOR HANDLE

(71) Applicant: The Gillette Company LLC, Bosaton, MA (US)

(72) Inventors: Christopher James Wattam, Windsor (GB); Eduardo Romo Escalante, Reading (GB)

(21) Appl. No.: 15/906,014

(22) Filed: Feb. 27, 2018

(30) Foreign Application Priority Data
Mar. 10, 2017 (EP) 17160356.6

(51) Int. Cl. B26B 21/52; A45D 26/00

(52) U.S. Cl. CPC B26B 21/522; B26B 21/528; B26B 21/443; A45D 26/00; B26B 21/521

(57) ABSTRACT

The invention relates to a handle for a shaving razor having a 3-dimensional lattice framework structure to provide both ergonomic and economic benefits.

### FIELD OF THE INVENTION

The invention relates to a handle for razors which provides both consumer desirable ergonomics in terms of design and functionality, while reducing the amount of material required to manufacture the handle and thereby improve its sustainability and manufacturing costs.

### BACKGROUND OF THE INVENTION

A key challenge facing the consumer goods industry is the reduction of waste. This has importance both from the point of view of sustainability and also manufacturing costs. One option which has been considered to address this problem is to reduce the amount of raw material required to manufacture a product. In the field of hair removal products such as razors, a large amount of material is utilized in the manufacture of the handle portion. The handle's main purpose is to provide a consumer desirable handle, which provides ergonomic control over the blade unit to thereby enable a comfortable and effective shaving experience. However, the blade unit or cartridge has a limited lifetime, which is typically less than that of the handle. Consequently, at the end of the product's lifetime, material is wasted by the disposal of a functional handle.

Hence, there is a need to provide a razor handle which provides the consumer desired functionality in terms of ease of handling, ergonomics and aesthetic appeal to deliver a pleasing shaving experience, while reducing the amount of material utilized to manufacture the handle.

Razor handles are typically manufactured using injection molding or die-casting processes which typically utilize thermoplastics or metals and/or alloys respectively. The solid bodies which are produced by these methods may then be subsequently shelled out to remove excess material while retaining ergonomic and aesthetic appeal of the handle. The shelling out process may result in the creation of voids or hollows in the handle and/or the creation of apertures through the handle body. These voids or apertures may thereby create consumer relevant features such as ribs, which may improve consumer grip, rigidity and/or balance as described for example in WO 2015/128000. There are a number of such products available in the market today such as for example Walgreen's Sunny Smile, Schick Xtreme3 eco and Simply Venus Disposable. Alternatively, manufacturers have provided disposable razors which have a smaller overall design in order to reduce the amount of material utilized.

Nevertheless, these products still all utilize a large amount of material for the handle in order to ensure the consumer desired rigidity and stability in use. Moreover, the manufacture of the products is consequently more complex and expensive due to the additional shelling out process.

Another alternative described in the art is to produce a hollow tube like structure for the handle. The walls of this tube may be quite thin, while maintaining a degree of structural functionality, consequently the amount of material utilized can be considerably reduced. However, there are disadvantages to this method of construction and resulting handle. Firstly, this form creates manufacturing problems, particularly when injection molding parts of the handle. For example, the deep core of the tube can present significant cooling issues in the injection mold design increasing production costs. Secondly, the consumer may from the visual appearance of the handle gain an expectation of a product which is considerably heavier than its actual weight. Furthermore, there is a dichotomy between the consumer's desire for an aesthetically pleasing and functional handle which is sustainable and minimizes waste, with a desire for a product which is not perceived as lightweight and thus cheap and low quality.

### SUMMARY OF THE INVENTION

The invention relates to a shaving razor handle comprising an elongated body extending in a longitudinal direction (L), wherein a portion of said body is formed from a 3-dimensional lattice framework structure.

### BRIEF DESCRIPTION OF THE DRAWINGS

FIGS. 1a, 1b and 1c show a perspective, top and side views respectively of a first embodiment of the invention.

FIGS. 2a, 2b and 2c show a perspective, top and side view respectively of a second embodiment of the invention.

FIGS. 3a, 3b and 3c show a perspective, top and side view of a third embodiment of the invention.

FIGS. 4a, 4b and 4c show a perspective, top and side views of a fourth embodiment of the invention.

FIGS. 5a, 5b and 5c show a perspective, top and side views of a fifth embodiment of the invention.

FIGS. 6a, 6b and 6c show a perspective front and rear views of a sixth embodiment of the invention.

FIGS. 7a and 7b show the perspective view of the sixth embodiment and a representation of the effective volume of this embodiment.

FIGS. 8a, 8b and 8c show a perspective, top and side views of a seventh embodiment of the invention.

FIG. 9 shows a perspective view of a drawing of first prior art handle available at: http://oraline.net/Secure/Razor/Security Razor.

FIG. 10 shows a top view of a drawing of a second prior art handle Sunny Smile triple blade razor available at: https://www.walgreens.com/store/c/sunny-s mile-men's -triple-blade-razors/ID=prod6172077-product.

FIG. 11 shows a top view of a drawing of a third prior art handle Schick Xtreme3 eco.

### DETAILED DESCRIPTION OF THE INVENTION

This invention relates to a handle for a shaving razor which comprises a 3-dimensional lattice framework structure or space frame, as used in structural engineering, to provide at least a portion of the body of the handle. Lattice framework structures or space frames provide an equivalent functional rigidity to a solid structure, but are provided by a network of connected members. Consequently, the lattice framework or space frame forms a rigid three-dimensional volume, while requiring significantly less material than the solid equivalent. Accordingly, in this invention the lattice framework structure or space frame provides an ergonomically functional razor handle, having an equivalent volume to a solid, or semi-solid construction, thereby providing equivalent or improved functional benefits as a contemporary razor handle, but using far less material. In addition, the handle delivers both improved grip and ease of rinse through both during and after use.

Handle

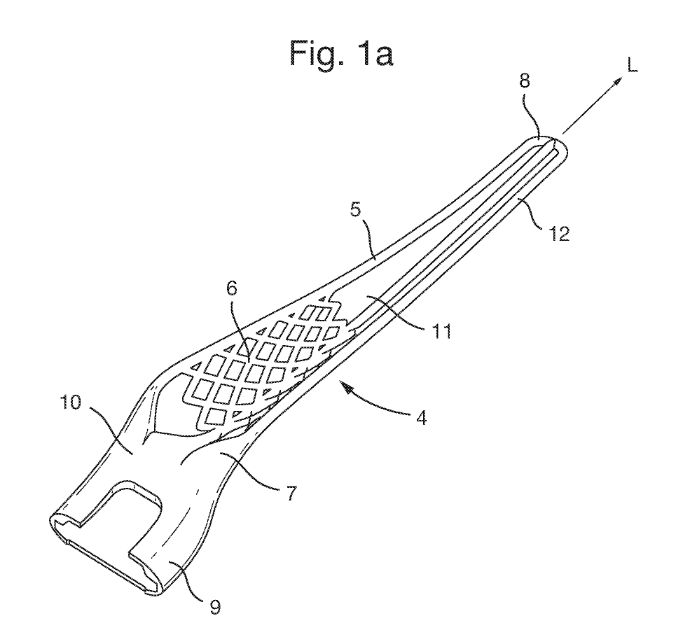

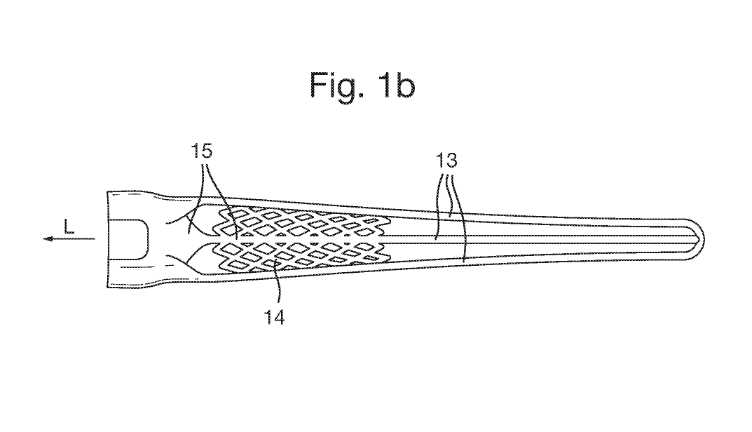

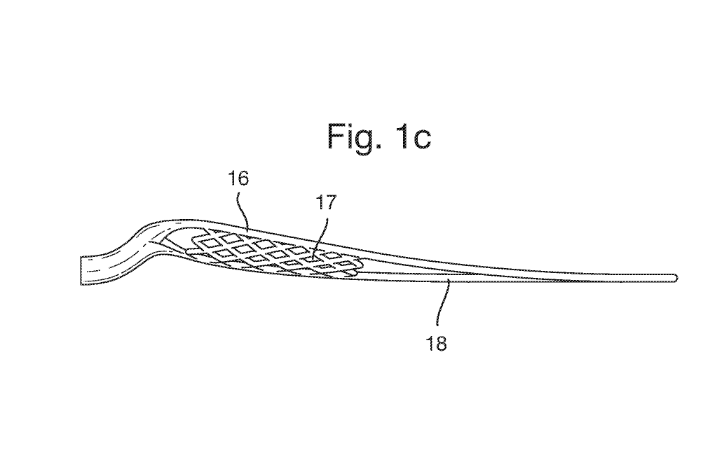

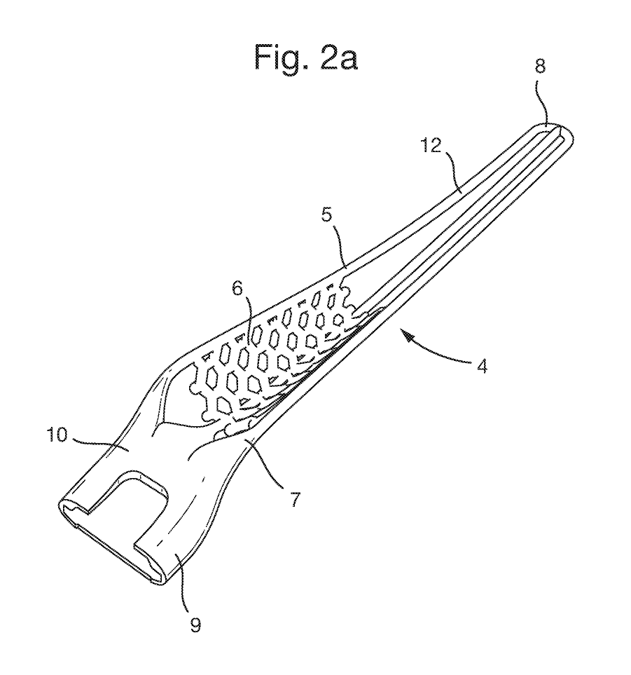

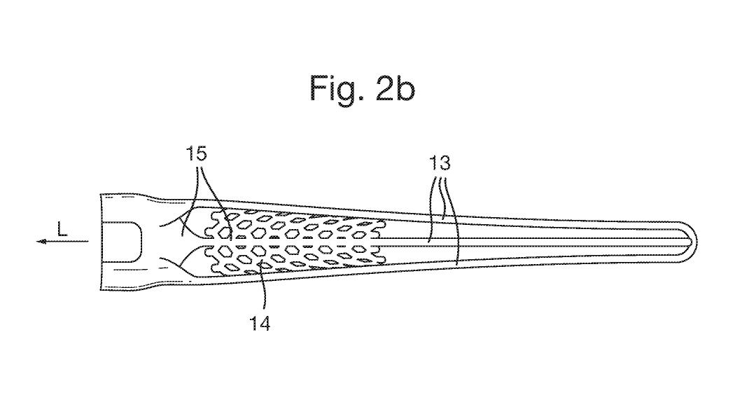

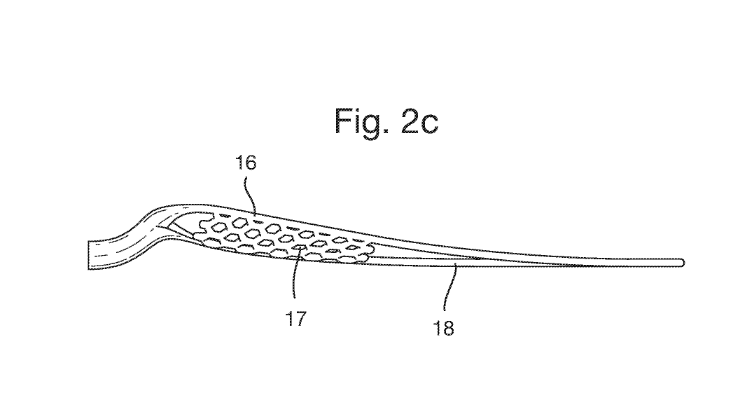

According to the invention, the handle (2) for a shaving razor comprises an elongated body (5) extending in a longitudinal direction (L). Referring to FIGS. 1a-1c, 2a-2c & 3a-3c, the body extends longitudinally between a proximal end (7) and a terminal end (8) of the handle (4). The handle (4) may comprise a neck portion (10), an intermediate portion (11) and a tail portion (12). The neck portion (10) may be located at the proximal end (7), the tail portion (12) may be located at the terminal end (8) and the intermediate portion (11) if present, may be located in-between the neck (10) and tail portion (12).

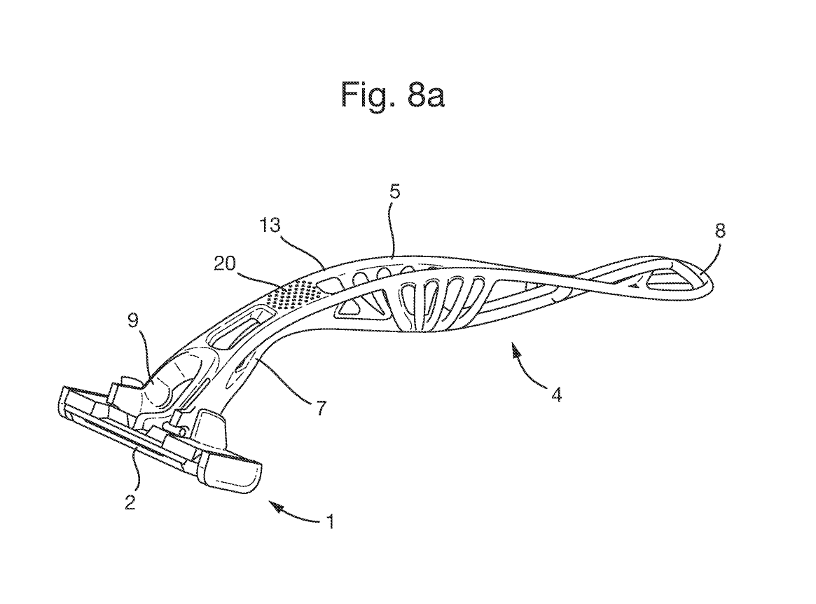

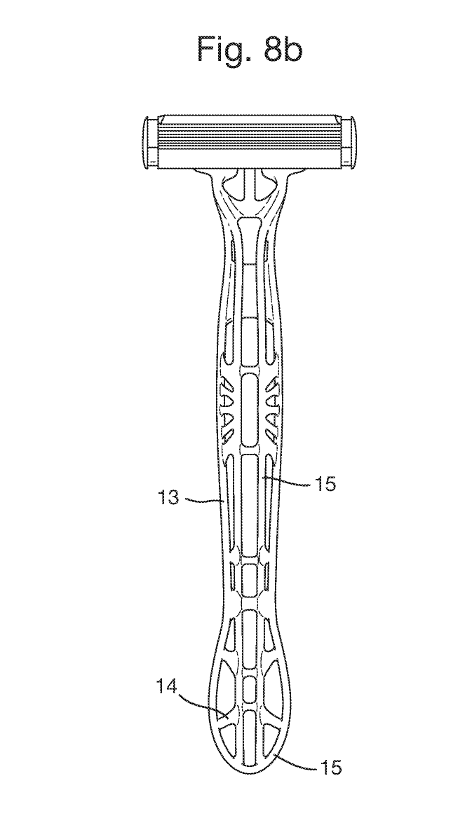

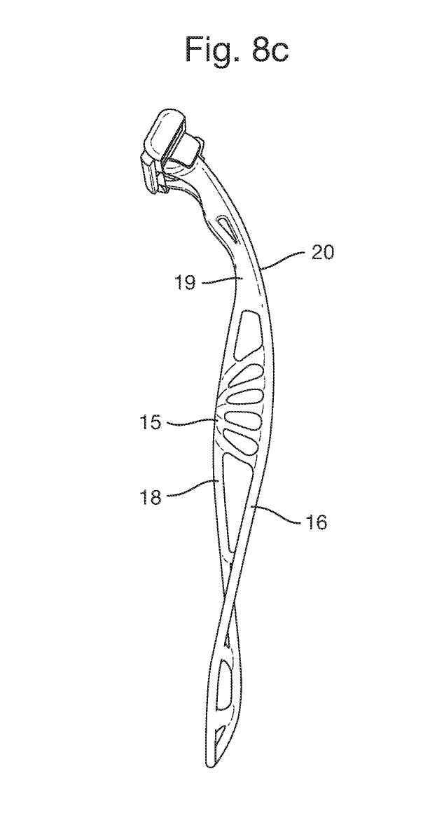

The handle (4) typically comprises a connecting means (9) to connect the handle (4) to a hair removal head (2), described hereinafter. The connecting means (9) may connect the handle (4) to the hair removal head (2) permanently (as shown for example in FIGS. 8a, 8b and 8c) or releasably to enable replacement with another hair removal head. The connecting means (9) is typically located in the neck portion (10) of the handle (4) and adjacent the hair removal head (2).

The handle (4) may be provided in any shape or form, but is preferably 3 dimensional and ergonomic to allow easy handling by the consumer. The handle may be symmetrical or asymmetrical, and is preferably symmetrical in form. In one embodiment, the handle has a curved shape.

According to the invention, at least a portion of the body of the handle is provided with a lattice framework structure (6). This portion may be located in any one of or combination of; the neck portion (10), intermediate portion (11) and tail portion (12) of the handle (4). In one embodiment, the lattice framework structure (6) is located in at least the intermediate portion (11) (as shown in embodiments 1 to 6 and 8). In another embodiment the lattice framework structure (6) is located in the tail portion (12). In yet another embodiment the lattice framework structure (6) is located in the neck (10), intermediate (11) and tail (12) portions of the handle. In yet another embodiment, the lattice frame structure (6) is located in the neck portion (10). In yet another embodiment, the body (5) may be substantially entirely formed from the lattice framework structure (6). In another embodiment, the body may in addition to the lattice framework structure (6) have a portion which is formed from a traditional solid body form or solid shelled or hollowed out body form.

As used herein the term 3-dimensional lattice framework structure or space frame is a structure system assembled or formed from elements to form a network such that forces are transferred in a three-dimensional manner upon the application of a load and that members of the lattice and the apertures of voids between the members are visible when viewed from at least 2 orthogonal planes. Hence as used herein the term 3 dimensional may refer to a handle which preferably has at least minimal dimensions of about 4 mm by 4 mm by 20 mm, preferably about 12 mm by 12 m by 130 mm.

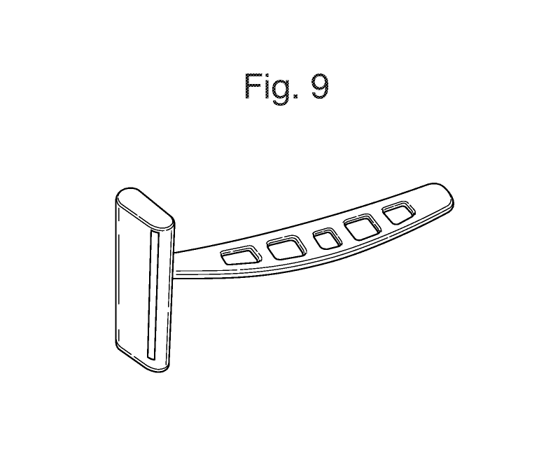

Macroscopically, a space frame may take the form of a flat or curved surface. The three-dimensional lattice structure is thus made up of a network of elements which create a plurality of apertures as opposed to a continuous surface, thereby creating an effective enclosed volume and providing structural integrity. Substantially flat or 2 dimensional frameworks as depicted in the prior art (see for example FIG. 9) are not considered as a 3-dimensional lattice framework structure as defined herein.

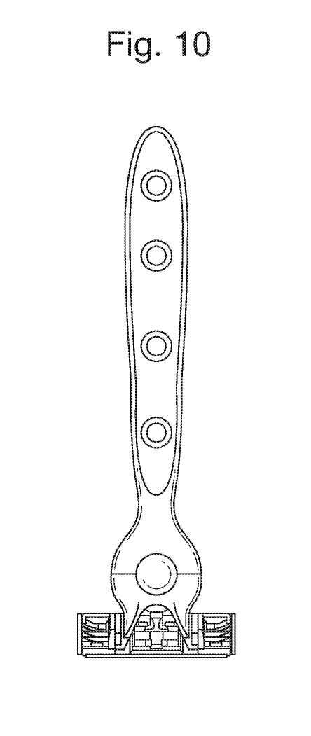

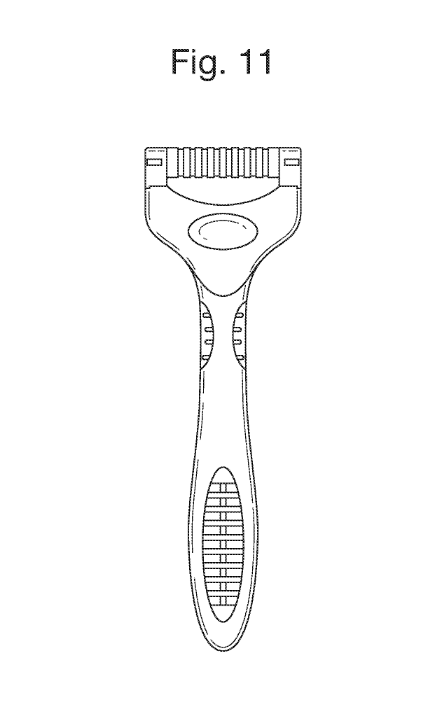

Similarly, handles having shelled out sections of a solid body as shown in FIGS. 10 and 11 are also not considered as 3-dimensional lattice framework structures.

In another embodiment, the body (5) of the handle (4) may comprise more than 1 lattice, preferably 2, more preferably 3 framework structures (6). Each lattice framework structure may have an identical or unique configuration. Embodiments which comprise more than 1 lattice structure framework may be separated from one another by the provision of a section of the body which does not contain a lattice framework structure such as for example a solid body spacer form. The 3-dimensional lattice framework structure may comprise from 5% to 100%, or from 10% to 90% or from 40% to 80% of the volume of the body of the handle.

Each lattice framework (6) present in the body portion (5) may independently comprise at least 3, preferably at least 4, longitudinally extending members (13) as shown in embodiments 1, 2 and 3 and embodiments 4, 5, 6 and 7 respectively. In one embodiment, the longitudinally extending members (13) may extend from the neck portion (10) of the handle to the tail portion (12) of the handle.

Alternatively, the longitudinal members (13) may extend from the neck portion (10) to the intermediate portion (11) or extend within the intermediate portion or from the intermediate portion to the tail portion (12).

The longitudinally extending members (13) may each be independently curved or substantially linear. At least two of the longitudinally extending members (13) may be substantially parallel to one another. In another embodiment, at least two of the longitudinally extending members (13) are mirror images of one another about a mirror plane.

In one embodiment, the longitudinally extending members (13) are interconnected with one another in order to form a lattice framework to provide the handle with the desired ergonomic and aesthetic appeal while reducing material usage. In one embodiment, each longitudinally extending member (13) is interconnected with at least one adjacent longitudinally extending member (13). In another embodiment, at least two adjacent longitudinally extending members (13) are interconnected with one another.

In one embodiment, each longitudinally extending members (13) is interconnected with an adjacent longitudinally extending member by at least one, preferably at least two horizontally/perpendicularly extending members (14). Each longitudinally extending member may interconnect with an adjacent longitudinally extending member at a respective interconnection point preferably by a horizontally/perpendicularly extending member (14). In one embodiment, two adjacent longitudinally extending members (13) intersect and/or connect at the neck portion (10) and/or tail portion (12) of the body (5) of the handle (4). As used herein the terms connected or interconnected refers to 2 or more members that are mechanically or chemically permanently joined to one another at an interconnection point. Suitable mechanical means include mechanical pinning, riveting or bolting. Suitable chemical means include chemical, thermal or ultrasonic bonding. These interconnection points (15) may be formed as part of a manufacturing process producing a unit body whereby the interconnection points between respective members are formed during the manufacturing process itself.

Accordingly, each lattice framework structure (6) may independently comprise of at least 2, preferably at least 3, more preferably at least 6, even more preferably at least 10 perpendicularly/horizontally extending members (14).

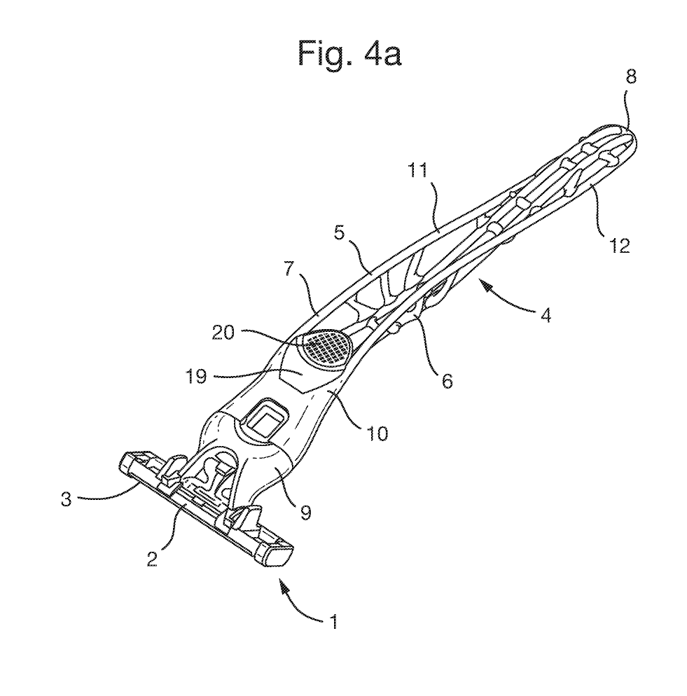

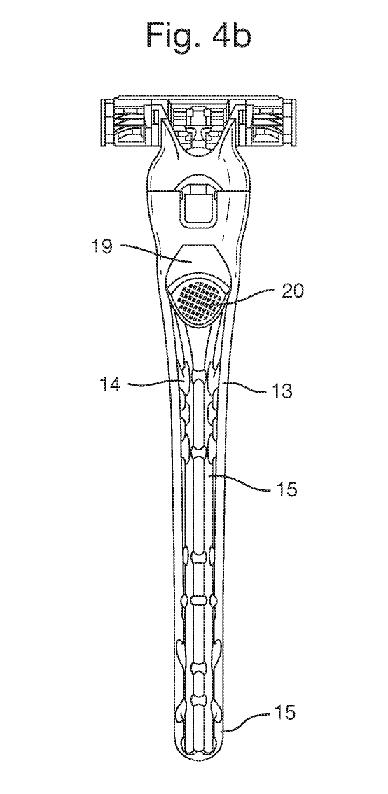

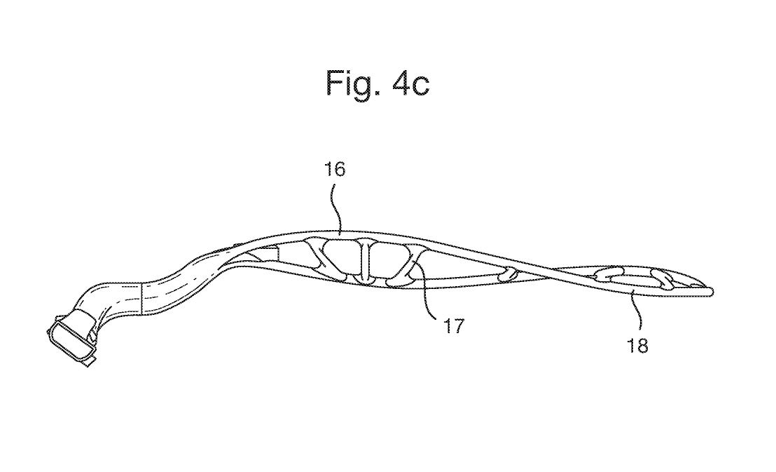

In one embodiment, a single perpendicular extending member (14) may interconnect more than 2, preferably at least 3, more preferably at least 4 longitudinally extending members (13) as shown in FIGS. 4a-4c, 5a-5c, 6a-6c and 8a-8c.

The term perpendicular extending member (14) as used herein includes members which are not necessarily horizontal or perpendicular to the longitudinal members but which preferably interconnect two such members.

In another embodiment, the perpendicularly extending members (14) may interconnect with adjacent perpendicular extending members as shown for example in embodiments 1 to 6 and 8.

The longitudinally and perpendicularly extending members may have any cross-sectional configuration. In one embodiment, the members have a uniform cross section along their respective lengths. In one embodiment, the longitudinally and horizontally extending members may have a substantially uniform circular cross section or oval cross section. The longitudinal members may be hollow or filled or solid.

Each lattice framework structure (6) may comprise at least 4, preferably at least 8, more preferably at least 10, or more preferably at least 16, or more preferably at least 20 apertures. Such apertures are formed by the intersection of the longitudinally extending members with the perpendicular extending members. Such apertures may form a regular repeating pattern of lattice structure framework or may be irregular. The apertures may have any shape or size and may have dimensions in the range of about 1 mm by 1 mm to about 70 mm by 13 mm.

Handles incorporating the lattice framework structure will consequently have an effective enclosed volume of the handle and an actual volume of material used. The ratio of the effective enclosed volume to the actual volume of the open frame structure, referred to hereinafter as percentage volume is from 20% to 80%, preferably from 25% to 50%.

The percentage volume is calculated by dividing the actual volume of material that the part occupies by the effective volume. This is determined using computer aided design (CAD) software (such as Dassault Systems Solidworks). Firstly, the software calculates the volume of material used to produce the part, determining the actual volume. Secondly, the computer model is modified to represent the effective volume. This is achieved by forming a solid body from the part in CAD to forming the effective volume and using the software to calculate this volume. This was assessed for the handle/elongated body of the handle of the razor (not the razor cartridge, as the cartridge value would be the same for both the effective volume and actual volume models).

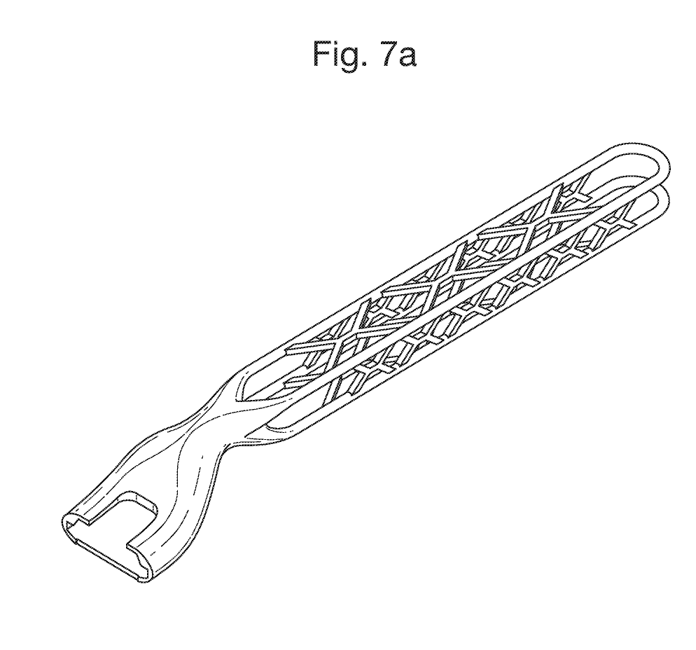

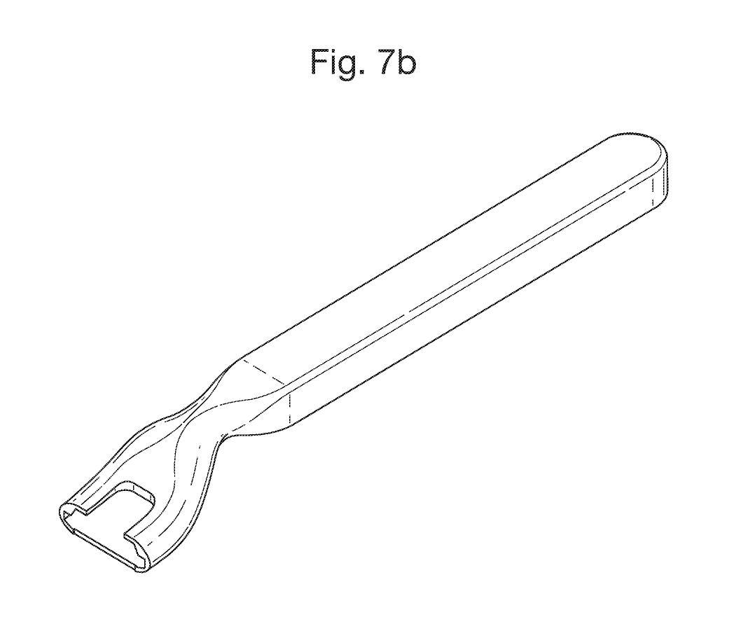

For example, in the example of a largely cuboid handle shape, the actual volume would be the volume of material forming the rails and struts i.e. longitudinal and perpendicular extending members of the framework. The effective volume would be the volume of the cuboid formed by forming a solid shape of this handle, by enclosing by the outermost extents of the framework. This is shown in FIGS. 7a and 7b and is 31.9%.

In one embodiment, the handle (4) may further be provided with a finger rest (20) to provide improved consumer control of the razor handle in use as shown for example in FIGS. 4a, 4b, 4c, 5a, 5b, 5c and 8a, 8b, 8c. The finger rest may be located at any suitable location on the body of the handle. Typically, the finger rest (20) is located at the proximal end (8), and may be located at the neck portion (10). The finger rest may have an indent and/or a visual or tactile cue to aid the consumer to locate the finger(s) at the appropriate position.

The handle (4) may be formed from any suitable materials known in the art. In one embodiment, the body portion comprising the lattice framework structure is formed from thermoplastic materials such as polypropylene, acrylonitrile butadiene styrene, high impact polystyrene, polycarbonate, polyphenylene ether/polystyrene blend; metals, or alloys such as zinc, aluminium, steel, titanium, stainless steel, brass, carbon fibre, and/or mixtures thereof. The handle typically has a weight of from 1 g to 35 g, preferably from 2 g to 15 g, most preferably from 1 g to 5 g. The most preferred weight range is typically provided when utilizing thermoplastic materials for the handle manufacture.

Methods of manufacture A shaving razor handle and/or body thereof may be manufactured using any method known in the art. Suitable methods include injection molding and die casting and optionally ‘additive or subtractive manufacturing’ techniques.

Hair Removal Head

According to some embodiments of the invention, the handle (2) is provided with a hair removal head (2). The hair removal head (2) can include a wide scraping surface such as where the hair removal device is used with a depilatory, or be a razor cartridge or foil where the device is a shaving razor.

The hair removal head may be replaceable and/or pivotally connected to a cartridge connecting structure and in turn or independently (e.g. permanently fixed) to the handle. In some embodiments, the cartridge connecting structure includes at least one arm to releasably engage the hair removal head.

The hair removal head (2) typically comprises one or more elongated edges usually positioned between a first and second end, said one or more elongated edges comprising a tip extending towards said first end. Where the hair removal head is a razor cartridge the one or more elongated edges can include blades (3). For example, U.S. Pat. No. 7,168,173 generally describes a Fusion® razor that is commercially available from The Gillette Company and which includes a razor cartridge with multiple blades. Additionally, the razor cartridge may include a guard as well as a skin engaging member. A variety of razor cartridges can be used in accordance with the present invention. Non-limiting examples of suitable razor cartridges, with and without fins, guards, and/or shave aids, include those marketed by The Gillette Company under the Fusion®, Venus® product lines as well as those disclosed in U.S. Pat. Nos. 7,197,825; 6,449,849; 6,442,839; 6,301,785; 6,298,558; 6,161,28; and U.S. Patent Publication No. 2008/060201. Those skilled in the art will understand that the lubricating member can be used with any currently marketed system or disposable razor, including those having 2, 3, 4 or 5 blades. In such a case, the hair removal device is a razor, the hair removal head is a razor cartridge and the one or more elongated edges are blades. Another example of a hair removal device is a scraping tool for use with a hair removal composition, i.e. a depilatory.

In some embodiments, at least one lubricating member is located on the portion of the cartridge that contacts skin during the hair removal process, forward and/or aft of the blades. A feature “forward” of the one or more elongated edges, for example, is positioned so that the surface to be treated with by the hair removal device encounters the feature before it encounters the elongated edges. A feature “aft” of the elongated edge is positioned so that the surface to be treated by the hair removal device encounters the feature after it encounters the elongated edges. Where more than one lubricating member is provided on the hair removal device, they can be the same (identical) or different, in terms of physical shape/structure and/or chemical composition, and one or more of them may comprise the spray coated particulate.

In some particular embodiments, a plurality (e.g. 2, a first and second) of lubricating members may be provided on the hair removal head, with the first skin engaging member comprising the same composition or different. These lubricating members may be placed collectively (for example adjacent to one another) ahead of or behind the elongated edges (e.g. blades on a razor cartridge), including side by side, or separately with one ahead of the elongated edges and the other behind.

The lubricating member may be free standing utilizing a suitable attachment means such as adhesive or may be contained at least partially within a container.

In some embodiments, the cartridge comprises a guard comprising at least one elongated flexible protrusion to engage a user's skin. The at least one flexible protrusion may comprise flexible fins generally parallel to said one or more elongated edges. Said at least one flexible protrusion may additionally or alternatively comprise flexible fins comprising at least one portion which is not generally parallel to said one or more elongated edges. Non-limiting examples of suitable guards include those used in current razor blades and include those disclosed in U.S. Pat. Nos. 7,607,230 and 7,024,776; (disclosing elastomeric/flexible fin bars); 2008/0034590 (disclosing curved guard fins); 2009/0049695A1 (disclosing an elastomeric guard having a guard forming at least one passage extending between an upper surface and a lower surface). In some embodiments, said lubricating member is positioned on the cartridge aft of the guard and forward of said elongated edge. In another embodiment, the lubricating member is positioned on the cartridge forward of the guard. This embodiment can be particularly useful to deliver the lubricating member prior to contact with the guard.

Exemplified Embodiments

The invention will now be further described with reference to specific exemplified embodiments of the invention.

FIGS. 1a, 1b and 1c show a first embodiment of the present invention. The embodiment comprises a handle (4) comprising an elongated body (5) comprising a proximal end (7) and a terminal end (8). The proximal end (7) has a connecting means (9) to enable attachment of a razor cartridge (not shown). The handle (4) comprises 3 longitudinally extending members (13) which extend from a solid body section in the neck portion (10) to the tail portion (12). Two of the longitudinal members (13) form the top portion (16) of the body (5) and are in the same plane and the remaining longitudinal member (13) is located in-between the other 2 members and forms the rear portion (18) of the body to provide a V like shape configuration. The longitudinally extending members (13) are interconnected respectively at the neck (10) and tail portions (12) at interconnection points (15). The handle (4) further comprises a plurality of perpendicularly extending members (14) which interconnect with the longitudinally extending members (13) at interconnection points (15). Each longitudinal member (13) is connected to at least one adjacent longitudinal member (13). The perpendicularly extending members (14) are interconnected with adjacent perpendicular members to form a diamond shaped lattice form.

FIGS. 2a, 2b and 2c show a second embodiment of the present invention based upon embodiment 1, where the perpendicularly extending members (13) exhibit an alternative configuration, which form a honeycomb shaped lattice form.

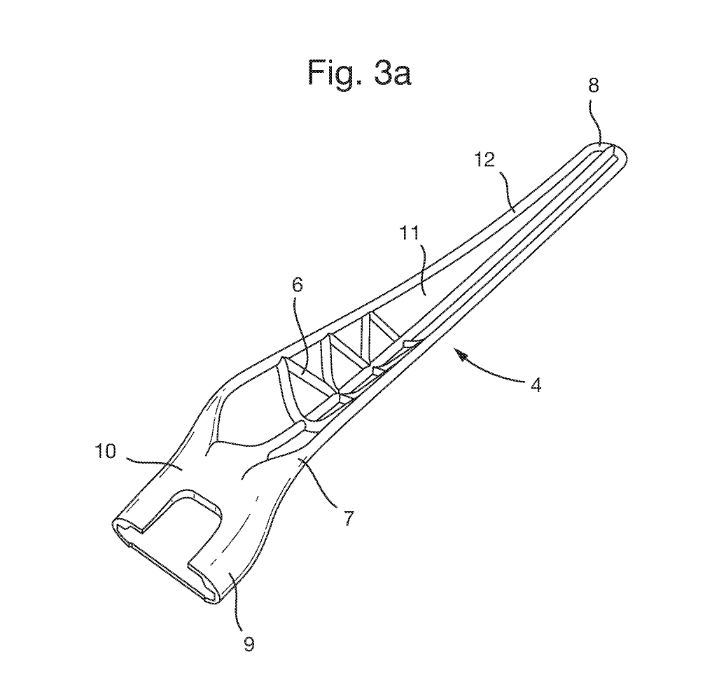

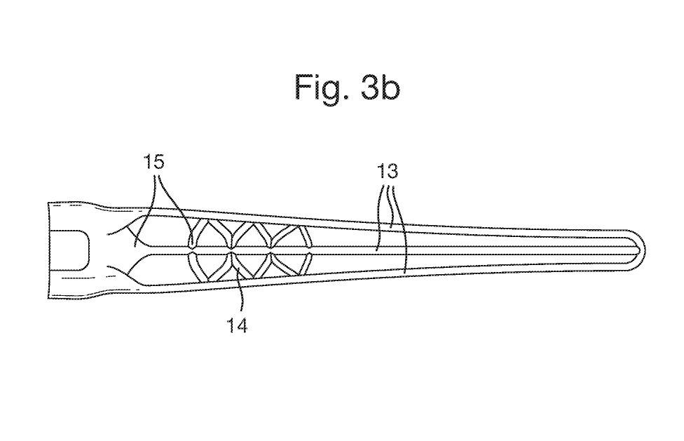

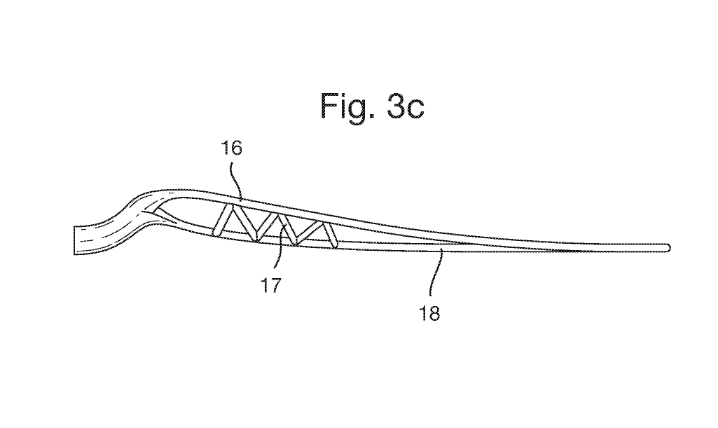

FIGS. 3a, 3b and 3c show a third embodiment of the invention based upon embodiment 1, where perpendicularly extending members (13) exhibit an alternative configuration comprising 6 such perpendicularly extending members extending from each longitudinal member (13) in the top portion (16) to the longitudinal member (13) in the rear portion (18).

FIGS. 4a, 4b and 4c show a fourth embodiment of the invention. The embodiment comprises a razor (1) comprising a handle (4) comprising an elongated body (5) comprising a proximal end (7) and a terminal end (8). The proximal end (7) has a connecting means (9) to attach the handle (4) to the razor cartridge (2). The handle (4) comprises 4 longitudinally extending members (13) which extend from a solid body section (19) in the neck portion (10) to the tail portion (12). Two of the longitudinal members (13) substantially form the top portion of the body (16) and the remaining two longitudinal members are located in-between the other 2 members and forms the rear portion of the body (18). The longitudinally extending members (13) are interconnected respectively at the neck (10) and tail portions (12) at interconnection points (15). The handle (4) further comprises a plurality of perpendicularly extending members (14) which interconnect with the longitudinally extending members (13) at interconnection points (15). Each longitudinal member (13) is connected to at least one adjacent longitudinal member (13). The 2 members forming the top portion (16) are not directly interconnected with one another. The perpendicularly extending members (14) are also interconnected with adjacent members. The handle exhibits a curved overall configuration. The neck portion (10) further has a finger rest (20) located at the solid body section (19).

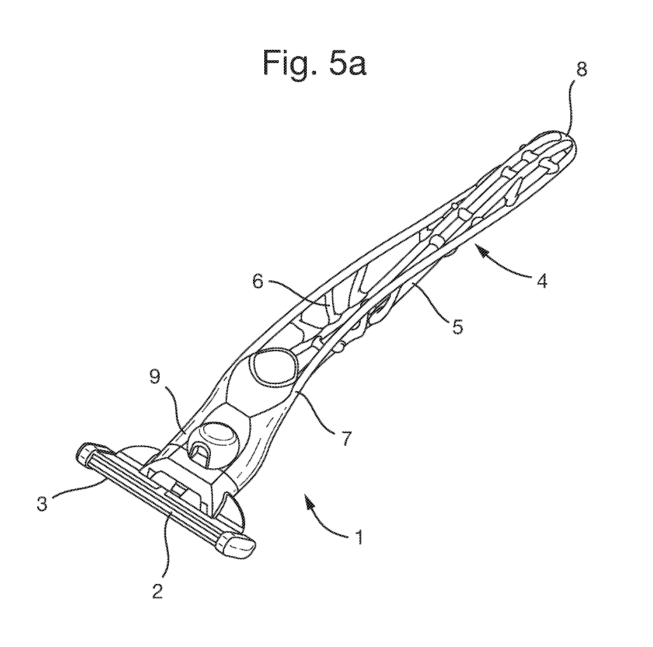

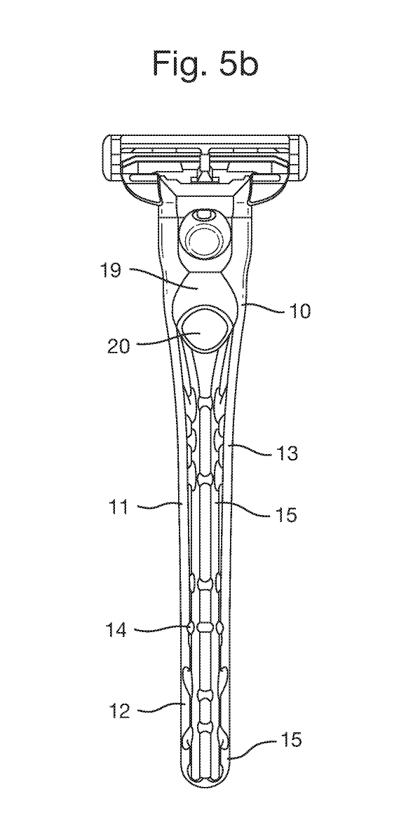

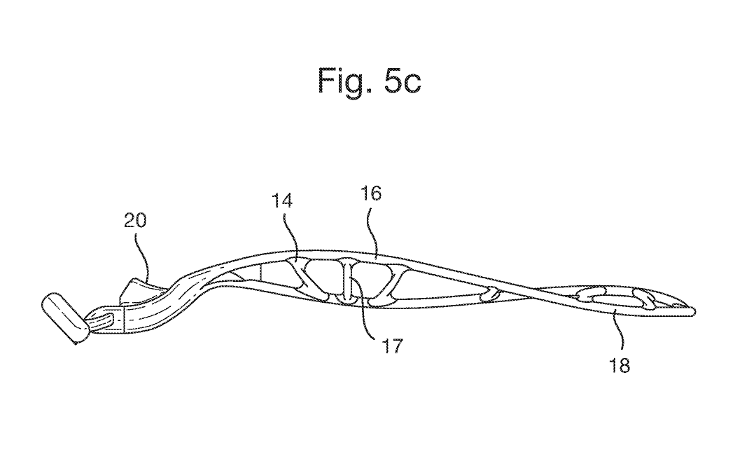

FIGS. 5a, 5b and 5c show a fifth embodiment of the invention. The embodiment comprises a razor (1) comprising handle (4) comprising an elongated body (5) comprising a proximal end (7) and a terminal end (8). The proximal end (7) has a connecting means (9) to attach the handle (4) to the razor cartridge (2). The handle (4) comprises 4 longitudinally extending members (13) which extend from a solid body section (19) in the neck portion (10) to the tail portion (12). Two of the longitudinal members (13) substantially form the top portion (16) of the body (5) and the remaining two longitudinal members (13) are located in-between the other 2 members and form the rear portion (18) of the body. The longitudinally extending members (13) are interconnected respectively at the neck (10) and tail (12) portions at interconnection points (15). The handle (2) further comprises a plurality of perpendicularly extending members (14) which interconnect with the longitudinally extending members (13) at interconnection points (15). Each longitudinal member (13) is connected to at least one adjacent longitudinal member (13). The two members forming the top portion (16) are not directly interconnected with one another. The perpendicularly extending members (14) are also interconnected with adjacent members. The handle exhibits a curved overall configuration. The neck portion (10) further has a finger rest (20) located at the solid body section (19). This embodiment has a ratio of effective enclosed volume to actual volume of open frame structure of 45.7% and a weight when formed from thermoplastic materials of between 2.5 g and 2.9 g.

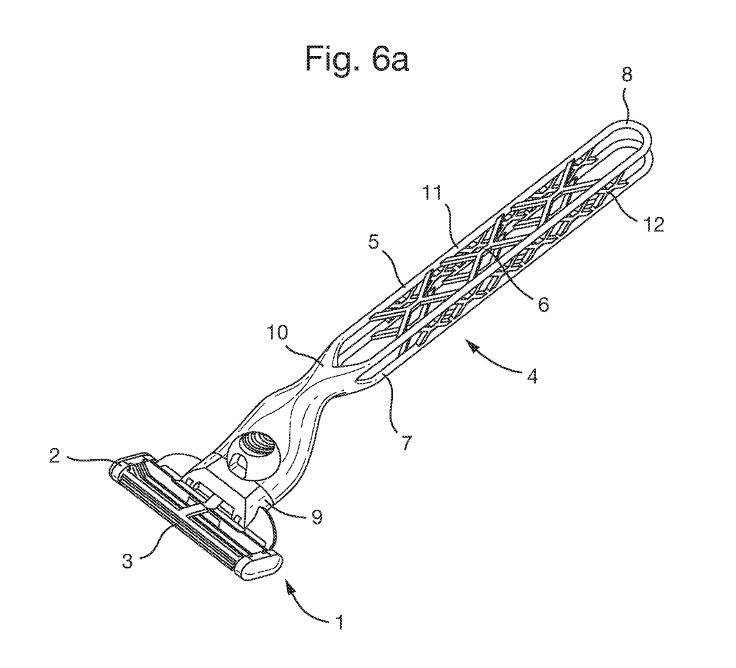

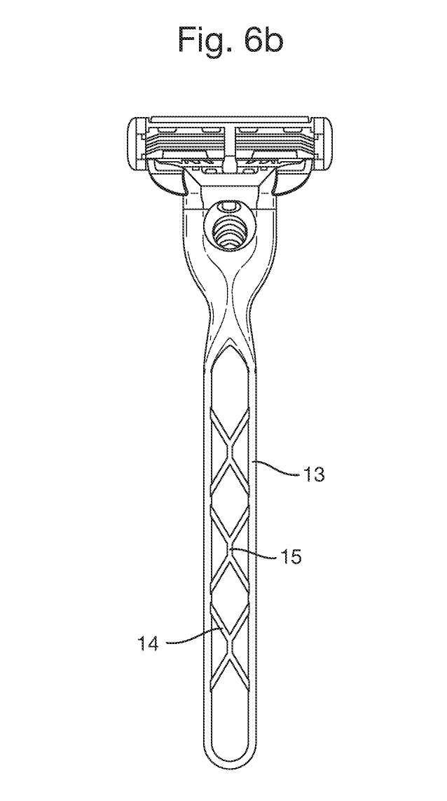

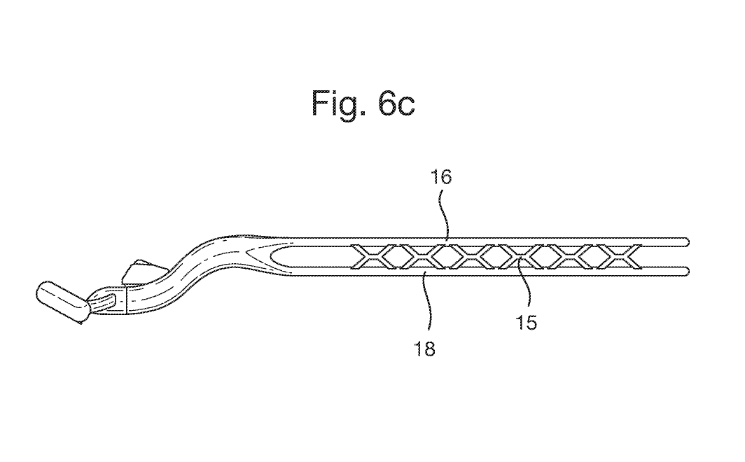

FIGS. 6a, 6b and 6c show a sixth embodiment of the invention. The embodiment comprises a handle (2) comprising an elongated body (5) comprising a proximal end (7) and a terminal end (8). The proximal end (7) has a connecting means (9) to attach the handle (4) to the razor cartridge (2). The handle (4) comprises 4 longitudinally extending members (13) which extend from a solid body section (19) in the neck portion (10) to the tail portion (12). 2 of the longitudinal members (13) substantially form the top portion (16) of the body and the remaining 2 longitudinal members (13) are located to form the rear portion (18) of the body. The longitudinally extending members (13) are interconnected respectively at the neck portion (10). The longitudinally extending members (13) of the top portion (16) are interconnected with one another at the terminal end (8) in the rear portion (18) at interconnection points (15). Similarly, the longitudinally extending members (13) of the rear portion (18) are interconnected with one another at the terminal end (8) at the tail portion (12) at interconnection points (15). The handle (4) further comprises a plurality of perpendicularly extending members (14) which interconnect with the longitudinally extending members (13) at interconnection points (15). Each longitudinal member (13) is connected to at least one adjacent longitudinal member (13). The perpendicularly extending members (14) are also interconnected with adjacent members. The neck portion (10) further has a finger rest (20) located at the solid body section (19). This embodiment has a ratio of effective enclosed volume to actual volume of open frame structure of 31.9% and a weight when formed from thermoplastic materials of between 2.4 g and 2.8 g.

FIGS. 8a, 8b and 8c show a seventh embodiment of the invention. The embodiment comprises a razor (1) comprising handle (4) comprising an elongated body (5) comprising a proximal end (7) and a terminal end (8). The proximal end (7) has a connecting means (9) to attach the handle (4) to the razor cartridge (2). The handle (4) comprises 4 longitudinally extending members (13) which extend from a solid body section (19) in the neck portion (10) to the tail portion (12). 2 of the longitudinal members (13) substantially form the top portion (16) of the body (5) and the remaining 2 longitudinal members (13) are located in-between the other 2 members and form the rear portion (18) of the body. The longitudinally extending members (13) are interconnected respectively at the neck (10) and tail (12) portions at interconnection points (15). The handle (2) further comprises a plurality of perpendicularly extending members (14) which interconnect with the longitudinally extending members (13) at interconnection points (15). Each longitudinal member (13) is connected to at least one adjacent longitudinal member (13). The perpendicularly extending members (14) are also interconnected with adjacent members. The handle exhibits a curved overall configuration. The neck portion (10) further has a finger rest (20) located at the solid body section (19). This embodiment has a weight when formed from thermoplastic materials of between 2.1 g and 2.4 g.

FIGS. 9, 10 and 11 show drawings of prior art razor handles commercially available or described on the internet. FIG. 9 shows a 2-dimensional handle as defined herein, whereas FIGS. 10 and 11 show handles having cored out sections.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition of the same term in a document incorporated by reference, the meaning of definition assigned to that term in this document shall govern.

While particular embodiments of the present invention have been illustrated, and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving razor handle comprising an elongated body extending in a longitudinal direction, wherein a portion of said body is formed from a 3-dimensional lattice framework structure.

2. A shaving razor handle according to claim 1, wherein said structure has an effective enclosed volume of said handle and an actual volume, wherein the ratio of the effective enclosed volume to the actual volume of the open frame structure is from about 20% to about 80%.

3. A shaving razor handle according to claim 1, wherein said body extends longitudinally between a proximal end and a terminal end, and wherein said proximal end comprises a connecting means.

4. A shaving razor handle according to claim 1, wherein said body comprises at least 3 longitudinally extending members.

5. A shaving razor according to claim 1, wherein said longitudinally extending members are curved or substantially linear.

6. A shaving razor handle according to claim 1, wherein said longitudinally extending members are interconnected.

7. A shaving razor handle according to claim 4, wherein said longitudinally extending members are interconnected by at least about 4 perpendicularly extending members.

8. A shaving razor handle according to claim 4, wherein said longitudinally extending members have a substantially circular cross section or oval cross section.

9. A shaving razor handle according to claim 7, wherein said longitudinally and perpendicularly extending members are interconnected with one another at interconnection points.

10. A shaving razor handle according to claim 4, wherein at least one longitudinal extending member is interconnected with an adjacent longitudinal member.

11. A shaving razor handle according to claim 4, wherein at least two adjacent longitudinally extending members are substantially parallel to one another,

12. A shaving razor handle according to claim 1, wherein said body is substantially entirely formed from a lattice framework structure.

13. A shaving razor handle according to claim 1, wherein said lattice framework structure comprises at least about 8 interconnected apertures.

14. A shaving razor handle according to claim 4, wherein said handle further comprises a neck portion and said longitudinally extending members, extend from said neck portion.

15. A shaving razor handle according to claim 4, wherein said longitudinal extending members interconnect at said terminal end.

16. A shaving razor handle according to claim 1, wherein said body is formed by injection molding, or casting.

17. A shaving razor handle according to claim 1, wherein said portion of said body comprises polypropylene, acrylonitrile butadiene styrene, high impact polystyrene, polycarbonate, polyphenylene ether/polystyrene blend, metals, carbon fiber, and/or mixtures thereof.

18. A shaving razor handle according to claim 1, wherein said body comprises zinc, aluminum, stainless steel, titanium, brass, carbon fiber and/or mixtures thereof.
